(19) United States
(12) Patent Application Publication
(10) Pub. No.: US 2026/0024298 A1
(43) Pub. Date: Jan. 22, 2026

(54) FOVEATION SENSING SYSTEMS WITH SYNCHRONOUS FOVEATION MODE SWITCHING

(71) Applicant: QUALCOMM Incorporated, San Diego, CA (US)

(72) Inventors: Pawan Kumar BAHETI, Bangalore (IN); Zhen LIU, San Diego, CA (US); Jiafu LUO, Irvine, CA (US)

(21) Appl. No.: 18/780,341

(22) Filed: Jul. 22, 2024

(51) Int. Cl. G06V 10/25

(52) U.S. Cl. CPC G06V 10/25

(57) ABSTRACT

Disclosed are systems, apparatuses, processes, and computer-readable media for generating one or more images. For example, a method includes generating a first frame from sensor data obtained from an image sensor, wherein the first frame has a first resolution; generating a first portion of the first frame from the sensor data based on information corresponding to a first region of interest (ROI); generating a second frame from the sensor data, wherein the second frame has a second resolution that is less than the first resolution; and outputting at least one of the first frame, the first portion of the first frame, or the second frame based on a foveation enable signal.

### FIELD

The present disclosure generally relates to capture and processing of images or frames. For example, aspects of the present disclosure relate to synchronous foveation mode switching.

### BACKGROUND

A camera can receive light and capture image frames, such as still images or video frames, using an image sensor. Cameras can be configured with a variety of image-capture settings and/or image-processing settings to alter the appearance of images captured thereby. Image-capture settings may be determined and applied before and/or while an image is captured, such as ISO, exposure time (also referred to as exposure, exposure duration, or shutter speed), aperture size, (also referred to as f/stop), focus, and gain (including analog and/or digital gain), among others. Moreover, image-processing settings can be configured for post-processing of an image, such as alterations to contrast, brightness, saturation, sharpness, levels, curves, and colors, among others.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein for performing compressed foveation. According to aspects described herein, devices using the disclosed compressed foveation can reduce bandwidth and power consumption based on reducing bandwidth of fovea regions. According to at least one example, a method is provided for generating one or more frames. The method includes: generating a first frame from sensor data obtained from an image sensor, wherein the first frame has a first resolution; generating a first portion of the first frame from the sensor data based on information corresponding to a first region of interest (ROI); generating a second frame from the sensor data, wherein the second frame has a second resolution that is less than the first resolution; and outputting at least one of the first frame, the first portion of the first frame, or the second frame based on a foveation enable signal.

In another example, an apparatus for performing a function is provided that includes at least one memory and at least one processor (e.g., implemented in circuitry) coupled to the at least one memory and configured to: generate a first frame from sensor data obtained from an image sensor, wherein the first frame has a first resolution; generate a first portion of the first frame from the sensor data based on information corresponding to a first region of interest (ROI); generate a second frame from the sensor data, wherein the second frame has a second resolution that is less than the first resolution; and output at least one of the first frame, the first portion of the first frame, or the second frame based on a foveation enable signal.

In another example, a non-transitory computer-readable medium is provided having stored thereon instructions that, when executed by at least one processor, cause the at least one processor to: generate a first frame from sensor data obtained from an image sensor, wherein the first frame has a first resolution; generate a first portion of the first frame from the sensor data based on information corresponding to a first region of interest (ROI); generate a second frame from the sensor data, wherein the second frame has a second resolution that is less than the first resolution; and output at least one of the first frame, the first portion of the first frame, or the second frame based on a foveation enable signal.

In another example, an apparatus for performing a function is provided that includes: means for generating a first frame from sensor data obtained from an image sensor, wherein the first frame has a first resolution; means for generating a first portion of the first frame from the sensor data based on information corresponding to a first region of interest (ROI); means for generating a second frame from the sensor data, wherein the second frame has a second resolution that is less than the first resolution; and means for outputting at least one of the first frame, the first portion of the first frame, or the second frame based on a foveation enable signal.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, each apparatus can include a camera or multiple cameras for capturing one or more images. In some aspects, each apparatus can include a display or multiple displays for displaying one or more images, notifications, and/or other displayable data. In some aspects, each apparatus can include one or more sensors (e.g., one or more inertial measurement units (IMUs), such as one or more gyroscopes, one or more gyrometers, one or more accelerometers, or any combination thereof, and/or other sensor.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following drawing figures:

FIG. 1 is a diagram illustrating an example of an image capture and processing system, in accordance with some examples;

FIG. 2A is a diagram illustrating an example of a quad color filter array, in accordance with some examples;

FIG. 2B is a diagram illustrating an example of a binning pattern resulting from application of a binning process to the quad color filter array of FIG. 2A, in accordance with some examples;

FIG. 3 is a diagram illustrating an example of binning of a Bayer pattern, in accordance with some examples;

FIG. 4 is a diagram illustrating an example of an extended reality (XR) system, in accordance with some examples;

FIG. 5 is a block diagram illustrating an example of an XR system with fovea compression in accordance with some aspects of the disclosure;

FIGS. 6A and 6B are conceptual illustrations of frames with different foveation regions in accordance with some aspects of the disclosure;

FIG. 7 illustrates an example block diagram of an image sensor including a synchronous foveation mode switch in accordance with some aspects of the disclosure;

FIG. 8A is a timing diagram illustrating operation of a foveation controller that is configured to incur delays due to image sensor mode reconfiguration;

FIGS. 8B and 8C are timing diagrams illustrating operation of synchronous foveation mode switching in accordance with some aspects of the disclosure;

FIG. 9 illustrates a conceptual diagram of an XR device for synchronous foveation mode switching in accordance with some aspects of the disclosure;

FIG. 10 is a flow diagram illustrating an example of a process for generating one or more compressed frames using foveated sensing, in accordance with some examples; and

FIG. 11 is a diagram illustrating an example of a computing system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Electronic devices (e.g., extended reality (XR) devices such as virtual reality (VR) devices, augmented reality (AR) devices, mixed reality (MR) devices, etc., mobile phones, wearable devices such as smart watches, smart glasses, etc., tablet computers, connected devices, laptop computers, etc.) are increasingly equipped with cameras to capture image frames, such as still images and/or video frames, for consumption. For example, an electronic device can include a camera to allow the electronic device to capture a video or image of a scene, a person, an object, etc. Additionally, cameras themselves are used in a number of configurations (e.g., handheld digital cameras, digital single-lens-reflex (DSLR) cameras, worn camera (including body-mounted cameras and head-borne cameras), stationary cameras (e.g., for security and/or monitoring), vehicle-mounted cameras, etc.).

A camera can receive light and capture image frames (e.g., still images or video frames) using an image sensor (which may include an array of photosensors). In some examples, a camera may include one or more processors, such as image signal processors (ISPs), that can process one or more image frames captured by an image sensor. For example, a raw image frame captured by an image sensor can be processed by an ISP of a camera to generate a final image. In some cases, a camera, or an electronic device implementing a camera, can further process a captured image or video for certain effects (e.g., compression, image enhancement, image restoration, scaling, framerate conversion, etc.) and/or certain applications such as computer vision, extended reality (e.g., augmented reality, virtual reality, and the like), object detection, image recognition (e.g., face recognition, object recognition, scene recognition, etc.), feature extraction, authentication, and automation, among others.

Cameras can be configured with a variety of image-capture settings and/or image-processing settings to alter the appearance of an image. Image-capture settings can be determined and applied before or while an image is captured, such as ISO, exposure time (also referred to as exposure, exposure duration, and/or shutter speed), aperture size (also referred to as f/stop), focus, and gain, among others. Image-processing settings can be configured for post-processing of an image, such as alterations to a contrast, brightness, saturation, sharpness, levels, curves, and colors, among others.

An XR device (e.g., a VR headset or head-mounted display (HMD), an AR headset or HMD, etc.) can output high-fidelity images at high resolution and at high frame rates. In XR environments, users are transported into digital worlds where their senses are fully engaged, and smooth motion is essential to prevent motion sickness and disorientation, which are common issues experienced at lower frame rates. By displaying images at a high frame rate, such as at 90 frames per second (FPS) or above, XR devices can minimize latency, maintain synchronization between the user movements and the visual feedback, and ensure low end-to-end processing time and reduce latency. Higher frame rates and low latency result in a more realistic and comfortable experience and ensure that human neural processing is engaged within the XR environment. Otherwise, the disconnect between the XR environment and the visual feedback received by the user creates motion sickness, disorientation, and nausea.

One application of XR devices is visual see-through (VST), which refers to the capability of XR devices, such as AR glasses or MR headsets, to overlay digital content seamlessly onto the user's real-world view. VST technology enables users to see and interact with their physical surroundings while augmenting them with virtual elements. By tracking the user's head movements and adjusting the position of digital content accordingly, VST technology ensures that virtual objects appear anchored to the real world, creating a convincing and integrated mixed reality experience.

Capturing images with varying resolutions and/or at varying frame rates can lead to a large amount of power consumption and bandwidth usage for systems and devices. For instance, a 16 megapixel (MP) or 20 MP image sensor capturing frames at 90 FPS can require 5.1 to 6.8 Gigabits per second (Gbps) of additional bandwidth. However, such a large amount of bandwidth may not be available on certain devices (e.g., XR devices). Foveation is one technique to reduce power consumption by varying detail in an image based on the fovea (e.g., the center of the eye's retina) that can identify salient parts of a scene (e.g., a fovea region) and peripheral parts of the scene (e.g., a peripheral region). The image sensor and/or the image signal processor (ISP) can produce high-resolution output for a foveated region where the user is focusing (or is likely to focus) and can produce a low-resolution output (e.g., a binned output) for the peripheral region.

Foveation will sometimes be disabled based on a state of an XR device and will need to switch between foveated and unfoveated output (e.g., foveated mode switch). For example, when an eye sensor loses a tracking state of an eye, the XR device is unable to identify the foveated region and may disable foveation (e.g., a foveation mode switch) until the ROI can be identified. In another example, in the event that the content is being recorded (e.g., a screenshot, a video, etc.), foveation will also need to be disabled to ensure that the captured content retains all details. Switching between a foveated mode and an unfoveated mode can incur delays due to the reconfiguration of the image sensor. As an example, the image sensor may send foveated content over a logical connection and apply binning to the image, and switching the image sensor to unfoveated needs to reconfigure the binning and output of the content within the image sensor. The reconfiguration includes programming registers and verifying the operation, which creates delays that can cause issues with displaying the content. For example, switching the image sensor between a foveated mode and an unfoveated mode can incur a 100 ms delay because only two logical channels are configured.

Systems, apparatuses, processes (also referred to as methods), and computer-readable media (collectively referred to as “systems and techniques”) are described herein for performing foveated sensing with synchronous foveation mode switching. For example, the image sensor is configured to provide an extra logical channel for the output of an unfoveated frame without reconfiguring the image sensor. The image sensor in this case does not need to be reconfigured by adding a logical channel for unfoveated frame, and the output of the unfoveated frame can occur on a frame-by-frame basis without any hardware changes.

In addition, the systems and techniques can concurrently output foveated and unfoveated frames to allow selective blending when switching between display modes. For example, the unfoveated content and the foveated content can be blended based on a duration to smooth the transition between foveated and unfoveated to make the transition seamless.

Various aspects of the application will be described with respect to the figures.

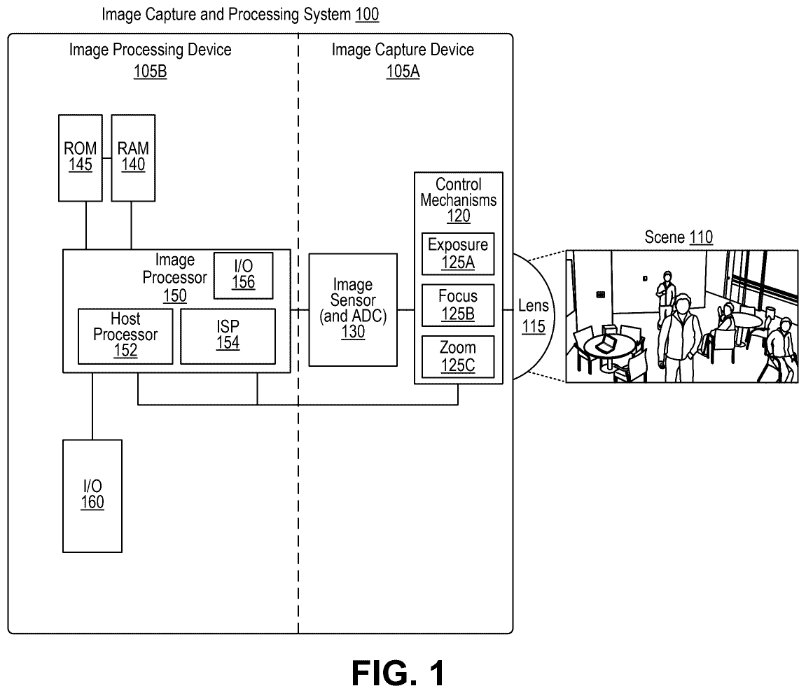

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the image capture and processing system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, high dynamic range (HDR), depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f-stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

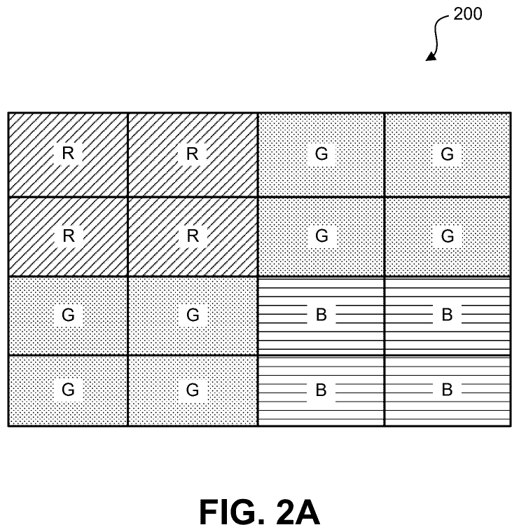

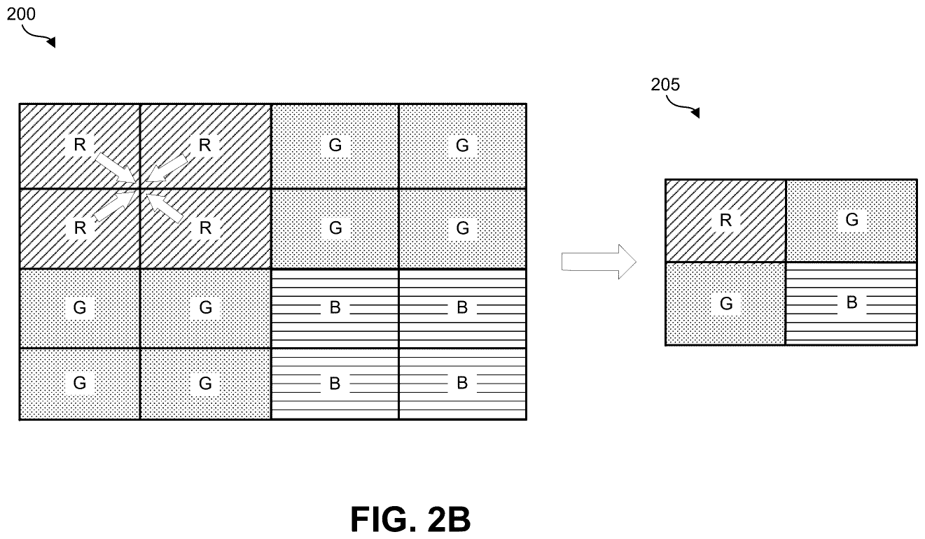

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters of a color filter array, and may thus measure light matching the color of the color filter covering the photodiode. Various color filter arrays can be used, including a Bayer color filter array, a quad color filter array (also referred to as a quad Bayer filter), and/or other color filter array. FIG. 2A is a diagram illustrating an example of a quad color filter array 200. As shown, the quad color filter array 200 includes a 2×2 (or “quad”) pattern of color filters, including a 2×2 pattern of red (R) color filters, a pair of 2×2 patterns of green (G) color filters, and a 2×2 pattern of blue (B) color filters. The pattern of the quad color filter array 200 shown in FIG. 2A is repeated for the entire array of photodiodes of a given image sensor. As shown, the Bayer color filter array includes a repeating pattern of red color filters, blue color filters, and green color filters. Using either quad color filter array or the Bayer color filter array, each pixel of an image is generated based on red light data from at least one photodiode covered in a red color filter of the color filter array, blue light data from at least one photodiode covered in a blue color filter of the color filter array, and green light data from at least one photodiode covered in a green color filter of the color filter array. Other types of color filter arrays may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for PDAF. The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more ISPs (including ISP 154), one or more host processors (including host processor 152), and/or one or more of any other type of processor 1110 discussed with respect to the computing system 1100. The host processor 152 can be a digital signal processor (DSP) and/or other type of processor. The image processor 150 may store image frames and/or processed images in random access memory (RAM) 140/1125, read-only memory (ROM) 145/1120, a cache 1112, a memory unit 1115, another storage device 1130, or some combination thereof.

In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), GPUs, broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a MIPI (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The host processor 152 of the image processor 150 can configure the image sensor 130 with parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames. The host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. For example, the processing blocks or modules of the ISP 154 can perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The settings of different modules of the ISP 154 can be configured by the host processor 152.

The image processing device 105B can include various input/output (I/O) devices 160 connected to the image processor 150. The I/O devices 160 can include a display screen, a keyboard, a keypad, a touchscreen, a trackpad, a touch-sensitive surface, a printer, any other output devices 1135, any other input devices 1145, or some combination thereof. In some cases, a caption may be input into the image processing device 105B through a physical keyboard or keypad of the I/O devices 160, or through a virtual keyboard or keypad of a touchscreen of the I/O devices 160. The I/O device 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, graphical processing units (GPUs), DSPs, CPUs, neural processing units (NPUs), and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

As noted above, a color filter array can cover the one or more arrays of photodiodes (or other photosensitive elements) of the image sensor 130. The color filter array can include a quad color filter array in some implementations, such as the quad color filter array 200 shown in FIG. 2A. In certain situations, after an image is captured by the image sensor 130 (e.g., before the image is provided to and processed by the ISP 154), the image sensor 130 can perform a binning process to bin the quad color filter array 200 pattern into a binned Bayer pattern. For instance, as shown in FIG. 2B (described below), the quad color filter array 200 pattern can be converted to a Bayer color filter array pattern (with reduced resolution) by applying the binning process. The binning process can increase signal-to-noise ratio (SNR), resulting in increased sensitivity and reduced noise in the captured image. In one illustrative example, binning can be performed in low-light settings when lighting conditions are poor, which can result in a high quality image with higher brightness characteristics and less noise.

FIG. 2B is a diagram illustrating an example of a binning pattern 205 resulting from application of a binning process to the quad color filter array 200. The example illustrated in FIG. 2B is an example of a binning pattern 205 that results from a 2×2 quad color filter array binning process, where an average of each 2×2 set of pixels in the quad color filter array 200 results in one pixel in the binning pattern 205. For example, an average of the four pixels captured using the 2×2 set of red (R) color filters in the quad color filter array 200 can be determined. The average R value can be used as the single R component in the binning pattern 205. An average can be determined for each 2×2 set of color filters of the quad color filter array 200, including an average of the top-right pair of 2×2 green (G) color filters of the quad color filter array 200 (resulting in the top-right G component in the binning pattern 205), the bottom-left pair of 2×2 G color filters of the quad color filter array 200 (resulting in the bottom-left G component in the binning pattern 205), and the 2×2 set of blue (B) color filters (resulting in the B component in the binning pattern 205) of the quad color filter array 200.

The size of the binning pattern 205 is a quarter of the size of the quad color filter array 200. As a result, a binned image resulting from the binning process is a quarter of the size of an image processed without binning. In one illustrative example where a 48 megapixel (48 MP or 48 M) image is captured by the image sensor 130 using a 2×2 quad color filter array 200, a 2×2 binning process can be performed to generate a 12 MP binned image. The reduced-resolution image can be upsampled (upscaled) to a higher resolution in some cases (e.g., before or after being processed by the ISP 154).

In some examples, when binning is not performed, a quad color filter array pattern can be remosaiced (using a remosaicing process) by the image sensor 130 to a Bayer color filter array pattern. For example, the Bayer color filter array is used in many ISPs. To utilize all ISP modules or filters in such ISPs, a remosaicing process may need to be performed to remosaic from the quad color filter array 200 pattern to the Bayer color filter array pattern. The remosaicing of the quad color filter array 200 pattern to a Bayer color filter array pattern allows an image captured using the quad color filter array 200 to be processed by ISPs that are designed to process images captured using a Bayer color filter array pattern.

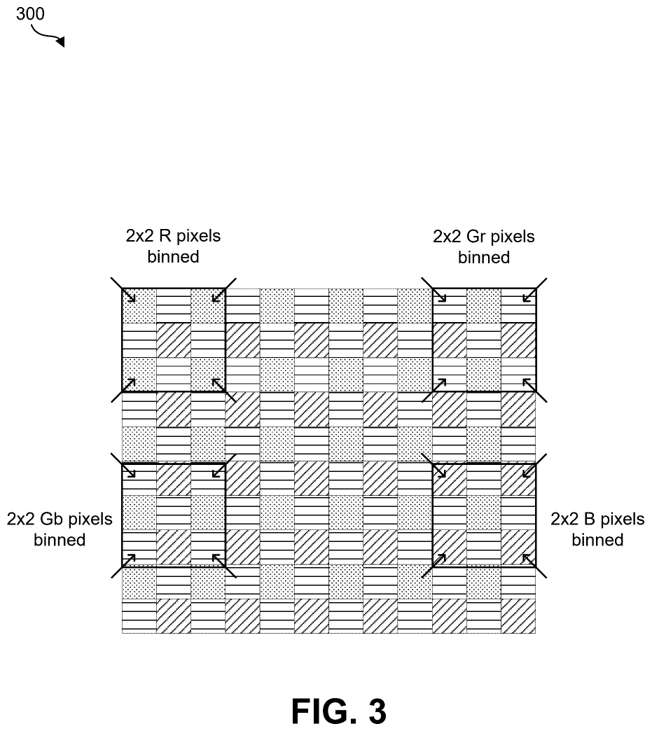

FIG. 3 is a diagram illustrating an example of a binning process applied to a Bayer pattern of a Bayer color filter array 300. As shown, the binning process bins the Bayer pattern by a factor of two both along the horizontal and vertical direction. For example, taking groups of two pixels in each direction (as marked by the arrows illustrating binning of a 2×2 set of red (R) pixels, two 2×2 sets of green (Gr) pixels, and a 2×2 set of blue (B) pixels), a total of four pixels are averaged to generate an output Bayer pattern that is half the resolution of the input Bayer pattern of the Bayer color filter array 300. The same operation may be repeated across all of the red, blue, green (beside the red pixels), and green (beside the blue pixels) channels.

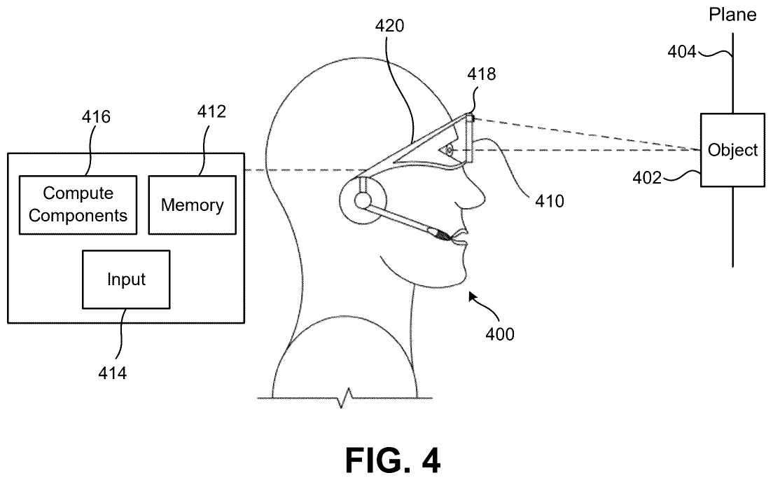

FIG. 4 is a diagram illustrating an example of an extended reality system 420 being worn by a user 400. While the extended reality system 420 is shown in FIG. 4 as AR glasses, the extended reality system 420 can include any suitable type of XR system or device, such as an HMD or other XR device. The extended reality system 420 is described as an optical see-through AR device, which allows the user 400 to view the real world while wearing the extended reality system 420. For example, the user 400 can view an object 402 in a real-world environment on a plane 404 at a distance from the user 400. The extended reality system 420 has an image sensor 418 and a display 410 (e.g., a glass, a screen, a lens, or other display) that allows the user 400 to see the real-world environment and also allows AR content to be displayed thereon. While one image sensor 418 and one display 410 are shown in FIG. 4, the extended reality system 420 can include multiple cameras and/or multiple displays (e.g., a display for the right eye and a display for the left eye) in some implementations. In some aspects, the extended reality system 420 can include an eye sensor for each eye (e.g., a left eye sensor, a right eye sensor) configured to track a location of each eye, which can be used to identify a focal point with the extended reality system 420. AR content (e.g., an image, a video, a graphic, a virtual or AR object, or other AR content) can be projected or otherwise displayed on the display 410. In one example, the AR content can include an augmented version of the object 402. In another example, the AR content can include additional AR content that is related to the object 402 or related to one or more other objects in the real-world environment.

As shown in FIG. 4, the extended reality system 420 can include, or can be in wired or wireless communication with, compute components 416 and a memory 412. The compute components 416 and the memory 412 can store and execute instructions used to perform the techniques described herein. In implementations where the extended reality system 420 is in communication (wired or wirelessly) with the memory 412 and the compute components 416, a device housing the memory 412 and the compute components 416 may be a computing device, such as a desktop computer, a laptop computer, a mobile phone, a tablet, a game console, or other suitable device. The extended reality system 420 also includes or is in communication with (wired or wirelessly) an input device 414. The input device 414 can include any suitable input device, such as a touchscreen, a pen or other pointer device, a keyboard, a mouse a button or key, a microphone for receiving voice commands, a gesture input device for receiving gesture commands, any combination thereof, and/or other input device. In some cases, the image sensor 418 can capture images that can be processed for interpreting gesture commands.

The image sensor 418 can capture color images (e.g., images having red-green-blue (RGB) color components, images having luma (Y) and chroma (C) color components such as YCbCr images, or other color images) and/or grayscale images. As noted above, in some cases, the extended reality system 420 can include multiple cameras, such as dual front cameras and/or one or more front and one or more rear-facing cameras, which may also incorporate various sensors. In some cases, image sensor 418 (and/or other cameras of the extended reality system 420) can capture still images and/or videos that include multiple video frames (or images). In some cases, image data received by the image sensor 418 (and/or other cameras) can be in a raw uncompressed format, and may be compressed and/or otherwise processed (e.g., by an ISP or other processor of the extended reality system 420) prior to being further processed and/or stored in the memory 412. In some cases, image compression may be performed by the compute components 416 using lossless or lossy compression techniques (e.g., any suitable video or image compression technique).

In some cases, the image sensor 418 (and/or other camera of the extended reality system 420) can be configured to also capture depth information. For example, in some implementations, the image sensor 418 (and/or other camera) can include an RGB-depth (RGB-D) camera. In some cases, the extended reality system 420 can include one or more depth sensors (not shown) that are separate from the image sensor 418 (and/or other camera) and that can capture depth information. For instance, such a depth sensor can obtain depth information independently from the image sensor 418. In some examples, a depth sensor can be physically installed in a same general location as the image sensor 418, but may operate at a different frequency or frame rate from the image sensor 418. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

In some implementations, the extended reality system 420 includes one or more sensors. The one or more sensors can include one or more accelerometers, one or more gyroscopes, one or more inertial measurement units (IMUs), and/or other sensors. For example, the extended reality system 420 can include at least one eye sensor that detects a position of the eye that can be used to determine a focal region that the person is looking at in a parallax scene. The one or more sensors can provide velocity, orientation, and/or other position-related information to the compute components 416. As noted above, in some cases, the one or more sensors can include at least one IMU. An IMU is an electronic device that measures the specific force, angular rate, and/or the orientation of the extended reality system 420, using a combination of one or more accelerometers, one or more gyroscopes, and/or one or more magnetometers. In some examples, the one or more sensors can output measured information associated with the capture of an image captured by the image sensor 418 (and/or other camera of the extended reality system 420) and/or depth information obtained using one or more depth sensors of the extended reality system 420.

The output of one or more sensors (e.g., one or more IMUs) can be used by the compute components 416 to determine a pose of the extended reality system 420 (also referred to as the head pose) and/or the pose of the image sensor 418. In some cases, the pose of the extended reality system 420 and the pose of the image sensor 418 (or other camera) can be the same. The pose of image sensor 418 refers to the position and orientation of the image sensor 418 relative to a frame of reference (e.g., with respect to the object 402). In some implementations, the camera pose can be determined for 6-Degrees Of Freedom (6DOF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference).

In some aspects, the pose of image sensor 418 and/or the extended reality system 420 can be determined and/or tracked by the compute components 416 using a visual tracking solution based on images captured by the image sensor 418 (and/or other camera of the extended reality system 420). In some examples, the compute components 416 can perform tracking using computer vision-based tracking, model-based tracking, and/or simultaneous localization and mapping (SLAM) techniques. For instance, the compute components 416 can perform SLAM or can be in communication (wired or wireless) with a SLAM engine (now shown). SLAM refers to a class of techniques where a map of an environment (e.g., a map of an environment being modeled by extended reality system 420) is created while simultaneously tracking the pose of a camera (e.g., image sensor 418) and/or the extended reality system 420 relative to that map. The map can be referred to as a SLAM map, and can be three-dimensional (3D). The SLAM techniques can be performed using color or grayscale image data captured by the image sensor 418 (and/or other camera of the extended reality system 420), and can be used to generate estimates of 6DOF pose measurements of the image sensor 418 and/or the extended reality system 420. Such a SLAM technique configured to perform 6DOF tracking can be referred to as 6DOF SLAM. In some cases, the output of one or more sensors can be used to estimate, correct, and/or otherwise adjust the estimated pose.

In some cases, the 6DOF SLAM (e.g., 6DOF tracking) can associate features observed from certain input images from the image sensor 418 (and/or other camera) to the SLAM map. 6DOF SLAM can use feature point associations from an input image to determine the pose (position and orientation) of the image sensor 418 and/or extended reality system 420 for the input image. 6DOF mapping can also be performed to update the SLAM Map. In some cases, the SLAM map maintained using the 6DOF SLAM can contain 3D feature points triangulated from two or more images. For example, key frames can be selected from input images or a video stream to represent an observed scene. For every key frame, a respective 6DOF camera pose associated with the image can be determined. The pose of the image sensor 418 and/or the extended reality system 420 can be determined by projecting features from the 3D SLAM map into an image or video frame and updating the camera pose from verified 4D-3D correspondences.

In one illustrative example, the compute components 416 can extract feature points from every input image or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The features points in key frames either match (are the same or correspond to) or fail to match the features points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Speed Up Robust Features (SURF), Gradient Location-Orientation histogram (GLOH), Normalized Cross Correlation (NCC), or other suitable technique.

In some examples, virtual objects (e.g., AR objects) can be registered or anchored to (e.g., positioned relative to) the detected features points in a scene. For example, the user 400 can be looking at a restaurant across the street from where the user 400 is standing. In response to identifying the restaurant and virtual content associated with the restaurant, the compute components 416 can generate a virtual object that provides information related to the restaurant. The compute components 416 can also detect feature points from a portion of an image that includes a sign on the restaurant, and can register the virtual object to the feature points of the sign so that the AR object is displayed relative to the sign (e.g., above the sign so that it is easily identifiable by the user 400 as relating to that restaurant).

The extended reality system 420 can generate and display various virtual objects for viewing by the user 400. For example, the extended reality system 420 can generate and display a virtual interface, such as a virtual keyboard, as an AR object for the user 400 to enter text and/or other characters as needed. The virtual interface can be registered to one or more physical objects in the real world. However, in many cases, there can be a lack of real-world objects with distinctive features that can be used as reference for registration purposes. For example, if a user is staring at a blank whiteboard, the whiteboard may not have any distinctive features to which the virtual keyboard can be registered. Outdoor environments may provide even less distinctive points that can be used for registering a virtual interface, for example based on the lack of points in the real world, distinctive objects being further away in the real world than when a user is indoors, the existence of many moving points in the real world, points at a distance, among others.

In some examples, the image sensor 418 can capture images (or frames) of the scene associated with the user 400, which the extended reality system 420 can use to detect objects and humans/faces in the scene. For example, the image sensor 418 can capture frames/images of humans/faces and/or any objects in the scene, such as other devices (e.g., recording devices, displays, etc.), windows, doors, desks, tables, chairs, walls, etc. The extended reality system 420 can use the frames to recognize the faces and/or objects captured by the frames and estimate a relative location of such faces and/or objects. To illustrate, the extended reality system 420 can perform facial recognition to detect any faces in the scene and can use the frames captured by the image sensor 418 to estimate a location of the faces within the scene. As another example, the extended reality system 420 can analyze frames from the image sensor 418 to detect any capturing devices (e.g., cameras, microphones, etc.) or signs indicating the presence of capturing devices, and estimate the location of the capturing devices (or signs).

The extended reality system 420 can also use the frames to detect any occlusions within a field of view (FOV) of the user 400 that may be located or positioned such that any information rendered on a surface of such occlusions or within a region of such occlusions are not visible to, or are out of a FOV of, other detected users or capturing devices. For example, the extended reality system 420 can detect the palm of the hand of the user 400 is in front of, and facing, the user 400 and thus within the FOV of the user 400. The extended reality system 420 can also determine that the palm of the hand of the user 400 is outside of a FOV of other users and/or capturing devices detected in the scene, and thus the surface of the palm of the hand of the user 400 is occluded from such users and/or capturing devices. When the extended reality system 420 presents any AR content to the user 400 that the extended reality system 420 determines should be private and/or protected from being visible to the other users and/or capturing devices, such as a private control interface as described herein, the extended reality system 420 can render such AR content on the palm of the hand of the user 400 to protect the privacy of such AR content and prevent the other users and/or capturing devices from being able to see the AR content and/or interactions by the user 400 with that AR content.

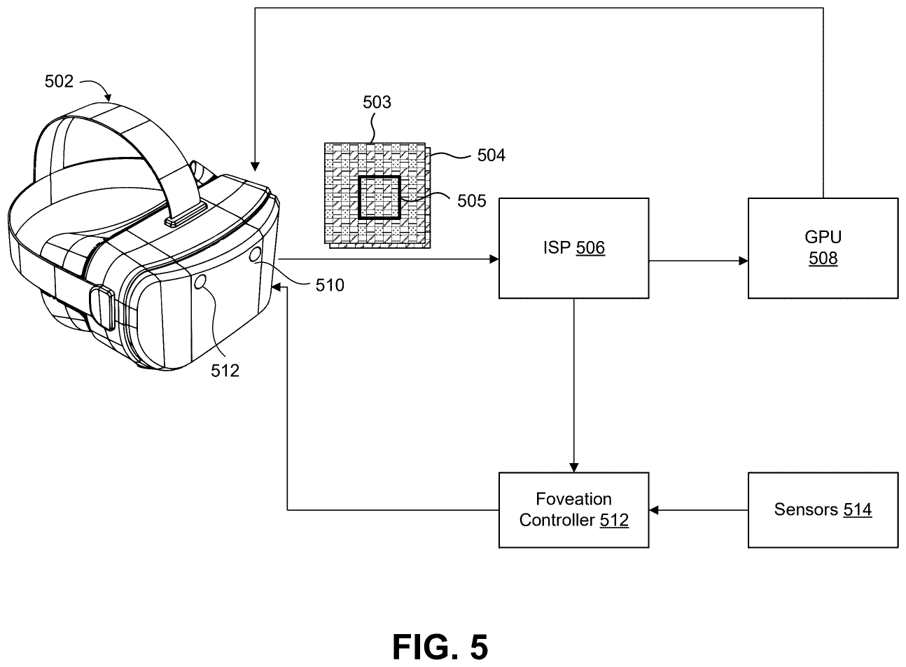

FIG. 5 illustrates an example of an XR system 502 with VST capabilities that can generate frames or images of a physical scene in the real-world by processing sensor data 503, 504 using an ISP 506 and a GPU 508. As noted above, virtual content can be generated and displayed with the frames/images of the real-world scene, resulting in mixed reality content. In some cases, the XR system 502 can include a memory (e.g., a cache memory, DDR, etc.) to store images between the various components. For example, the ISP 506 may store images in a memory (e.g., a cache memory, DDR, etc.) and the GPU 508 can retrieve the images from the memory to synthesize images for display within the XR system 502.

In the example XR system 502 of FIG. 5, the bandwidth requirement that is needed for VST in XR is high. There is also a high demand for increased resolution to improve the visual fidelity of the displayed frames or images, which requires a higher capacity image sensor, such as a 16 MP or 20 MP image sensor. Further, there is demand for increased framerate for XR applications, as lower framerates (and higher latency) can affect a person's senses and cause real world effects such as nausea. Higher resolution and higher framerates may result in an increased memory bandwidth, latency, and power consumption beyond the capacity of some existing memory systems.

In some aspects, an XR system 502 can include image sensors 510 and 512 (or VST sensors) corresponding to each eye. For example, a first image sensor 510 can capture the sensor data 503 and a second image sensor 512 can capture the sensor data 504. The two image sensors 510 and 512 can send the sensor data 503, 504 to the ISP 506. The ISP 506 processes the sensor data (to generate processed frame data) and passes the processed frame data to the GPU 508 for rendering an output frame or image for display. For example, the GPU 508 can augment the processed frame data by superimposing virtual data over the processed frame data.

In some cases, using an image sensor with 16 MP to 20 MP at 90 FPS may require 5.1 to 6.8 Gigabits per second (Gbps) of additional bandwidth for the image sensor. This bandwidth may not be available because memory (e.g., DDR memory) in current systems is typically already stretched to the maximum possible capacity. Improvements to limit the bandwidth, power, and memory are needed to support mixed reality applications using VST.

In some aspects, human vision sees only a fraction of the field of view at the center (e.g., 10 degrees) with high resolution. In general, the salient parts of a scene draw human attention more than the non-salient parts of the scene. Illustrative examples of salient parts of a scene include moving objects in a scene, people or other animated objects (e.g., animals), faces of a person, or important objects in the scene such as an object with a bright color.

In some aspects, systems and techniques may use foveation sensing to reduce bandwidth and power consumption of a system (e.g., an XR system, mobile device or system, a system of a vehicle, etc.). For example, the sensor data 503 and the sensor data 504 may be separated into two frames, processed independently, and combined at an output stage. For example, a fovea region 505 may be preserved with high fidelity and the peripheral region (e.g., the sensor data 503) may be downsampled to a lower resolution.

In some aspects, the ISP may include a compression engine 516 or a decompression engine (not shown). The compression engine 516 is configured to compress the fovea region 505 based on the peripheral region. In some aspects, the bits used in a low-resolution peripheral region frame may be used to compress the bits in a high-resolution fovea region.

The XR system 502 also may include a foveation controller 518 that receives motion information from one or more sensors 514 (e.g., an accelerometer, a gyrometer, etc.). The foveation controller 518 is configured to control the foveation of the XR system 502 based on the motion information (e.g., gaze movement, global motion applied to the XR system 502, etc.). The foveation controller 518 may also include various additional components to control foveation based on intrinsic information within the scene being captured by the image sensors 510 and the image sensors 512. For example, the foveation controller 518 may include object detection engines that identify objects that are moving within the scene, such as a person moving in the background.

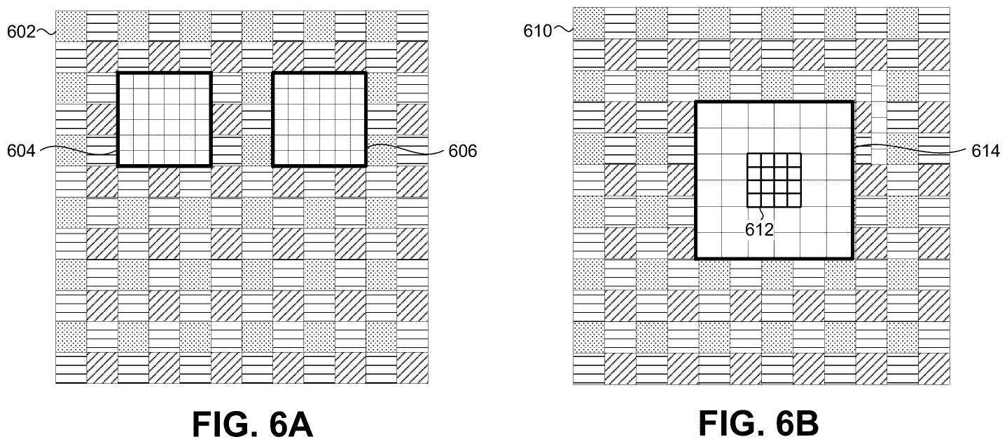

FIGS. 6A and 6B are conceptual illustrations of frames with different foveation regions in accordance with some aspects of the disclosure. FIG. 6A is a conceptual illustration of a frame 602 with a full FOV and includes a first fovea region 604 with a partial FOV, and a second fovea region 606 with a partial FOV. As shown in the frame 602, the fovea region 604 region is a region of interest (ROI) such as a focal region having a higher resolution than the frame 602. In one aspect, the fovea region 606 is another ROI (e.g., an area of local motion) and also has a higher resolution than the frame 602. For example, the XR system may detect that the local motion may cause the gaze of the user to change to the fovea region.

FIG. 6B in another conceptual illustration of a frame 610 with a full FOV and includes a first fovea region 612 that is within a second fovea region 614. The frame 610 has the lowest resolution, the first fovea region 612 has the highest resolution, and the second fovea region has an intermediate resolution. In this case, the fovea regions are gradients between the highest resolution and lowest resolution to reduce image artifacts and blending issues. The first fovea region 612, and the second fovea region 614 may also have a different frame rate (e.g., the frame 610 is output by an image sensor at 30 fps, the first fovea region 612 is output at 120 fps, and the second fovea region 614 is output at 60 fps). That is, the XR system can include multiple overlapping fovea regions that have different resolutions to improve image fidelity.

The XR system is configured to generate multiple streams of images having different resolutions. A stream refers to a sequence of data elements that are made available over time, such as a stream of images from an image sensor and often are used to represent continuous or dynamically changing data. Streams provide a flexible and efficient mechanism to handle potentially large or infinite datasets without loading the entire set of data (e.g., images) entirely into memory at once, and allow for sequential processing of data. The processing of streams allows applications to work with data incrementally, reducing memory usage and improving performance.

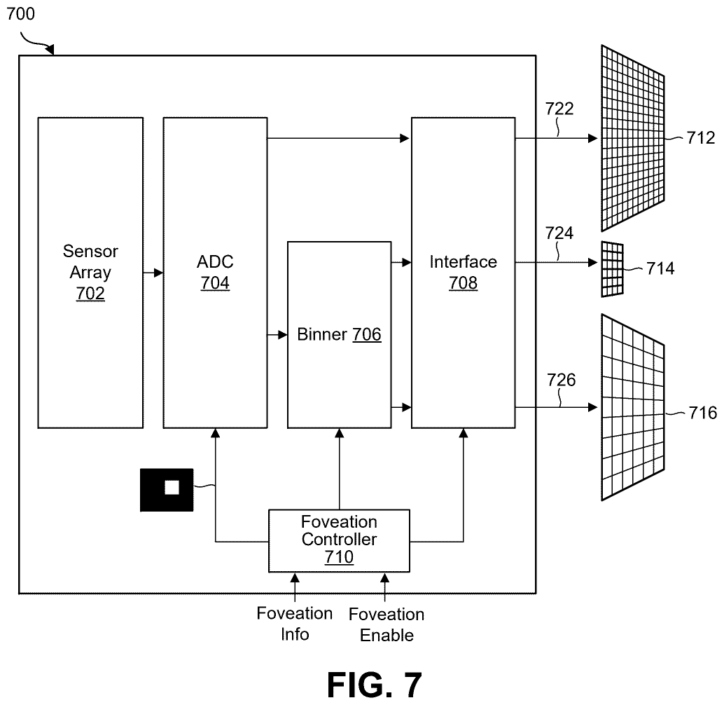

FIG. 7 illustrates an example block diagram of an image sensor 700 (e.g., a VST sensor) including a synchronous foveation mode switch in accordance with some examples. The image sensor 700 includes a sensor array 702 that is configured to detect light and output a signal that is indicative of light incident to the sensor array 702, such as an extended color filter array (XCFA) or a bayer filter, and provide the sensor signals to an ADC converter 704. The ADC 704 is configured to selectively convert the analog sensor signals into a first frame 712 (e.g., a raw digital image) and provides the first frame 712 to a binner 706 and an interface 708. The ADC 704 may also perform a selective readout of the sensor array 702 based on information from a foveation controller 710. For example, the ADC 704 may receive a mask from the foveation controller 710. The mask identifies a fovea region and a peripheral region. The ADC 704, depending on its configuration, can selectively read out columns or arrays of pixels, and provide fewer processing steps for the peripheral region. In some aspects, the ADC 704 may not receive a mask, and may then perform a full readout of the sensor array.

The binner 706 is configured to receive the first frame 712 from the ADC 704 and foveation information from a foveation controller 710. For example, the foveation controller 710 receives foveation information from a perception engine of an ISP (not shown), which includes a mask, a scaling ratio, and other information such as interleaving, etc. In some cases, the foveation controller 710 may also receive a foveation enable signal indicating whether to provide a foveated or unfoveated output.

The binner 706 receives the mask and is configured to generate and output at least a first portion 714 of the first frame at the first resolution (e.g., the original resolution) and a second frame 716 at a second resolution. For example, a pixel that corresponds to the black region of the mask is a peripheral region, and a transparent pixel that corresponds to the fovea region (e.g., corresponding to the first portion 714 of the first frame). In some aspects, the second frame is generated based on downsampling pixels (e.g., binning) from the first frame by a scaling ratio (e.g., two, etc.).

The interface 708 is configured to receive the first frame 712, the first portion 714 of the first frame, and the second frame 716. The interface also receives a select signal from the foveation controller 710 that identifies one or more logical channels to output the first frame 712, the first portion 714 of the first frame, and the second frame 716. For example, the interface 708 outputs the first frame 712 on a first logical channel 722, the first portion 714 of the first frame on a second logical channel 724, and the second frame 716 on a third logical channel 726.

In some aspects, the foveation controller 710 is configured to output pixels only on a logical interface (e.g., a virtual MIPI interface) and includes at least N+2 virtual channels with N being the number of levels of foveation. The image sensor 700 illustrates a first logical channel 722, a second logical channel 724, and a third logical channel 726 for a single level of foveation. In this example, the first frame 712 has a resolution corresponding to the output resolution of the image sensor 700 without additional processing and is an unfoveated frame. The second logical channel 724 is configured to output a first portion 714 of the first frame that corresponds to a foveated region, and the third logical channel 726 is configured to output a second frame 716 that is downsampled to a second resolution that is less than the first resolution (e.g., downsampled by a factor of 2).

In some aspects, the image sensor 700 is configured to output pixels on a different logical interface (e.g., a virtual MIPI interface) on a frame-by-frame basis and includes at least N+2 virtual channels with N being the number of levels of foveation. In some cases, the image sensor 700 may be configured to output both foveated and unfoveated output simultaneously on the corresponding logical channels. For example, when switching between a foveated and unfoveated mode, the ISP may be configured to blend the foveated and unfoveated output to create a seamless transition. For example, a user may visibly perceive the switch between foveated and unfoveated without any blending, and blending over a time duration (e.g., four frames) may reduce the sudden transition.

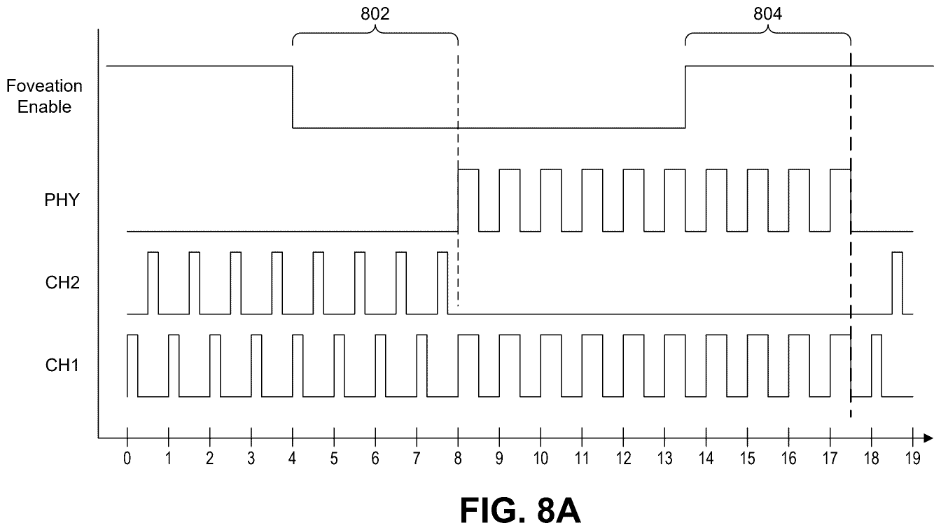

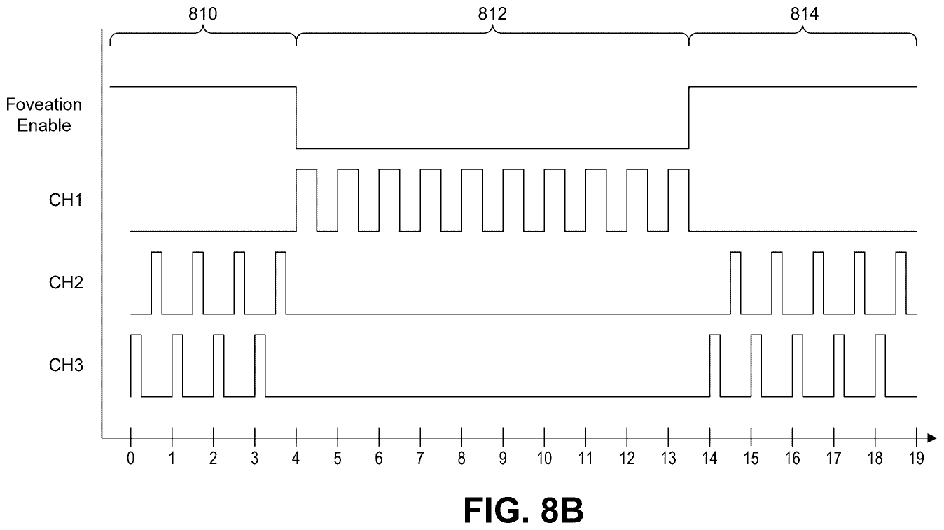

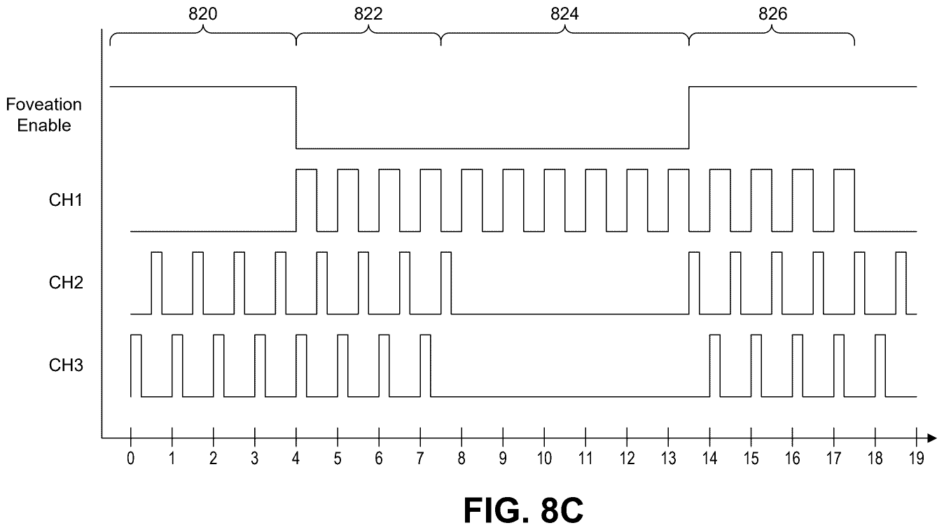

FIG. 8A is a timing diagram illustrating operation of a foveation controller that is configured to incur delays due to image sensor mode reconfiguration. In this example, at frame 0, the XR device is foveating a frame into two different frames and outputting the foveated frames on different logical channels (e.g., channel 1 and channel 2).

In this case, an enable signal becomes disabled by virtue of switching a logical low value at frame 4. The enable signal can become disabled based on, for example, capturing a screenshot or a video within the XR device. In another example, an eye tracking sensor can lose the tracking of the eye and is unable to determine what the ROI is and may disable foveation until tracking is restored. For example, the confidence in the eye tracking may fall below a particular confidence level. In other cases, a condition of a user, such as tracking a user a single eye, can be difficult. When the eye tracking is deemed lost at frame 4, foveation may become disabled and the image sensor is reconfigured to do a full readout of the image sensor. The image sensor reconfiguration requires a delay to program the registers, sense the registers, and verify the mode operation. For example, switching the mode can incur a 100 ms delay.

As noted above, the image sensor may need to be reconfigured when switching between a physical channel and logical channel configuration and incurs delays. Accordingly, the switching from the logical configuration incurs a delay 802 before the image sensor is ready to output frames. The delay 802 occurs due to reconfiguring registers and other hardware components necessary to switch between logical and physical channels.

After the delay 802, the image sensor is outputting frames on the physical channel until the enable signal indicates to enable foveation. Once again, the image sensor reconfigures the hardware components to switch between foveated output and unfoveated output, thereby introducing another delay 804. The switching between logical and physical connection incurs undesirable delays, degrades the user experience, and may reduce the fidelity of the experience. For example, if the eye tracking is lost, the XR device may be rendering foveated frames that do not align with the user's focal point, decreasing the visual fidelity of the content being presented to the user.

FIGS. 8B and 8C are timing diagrams illustrating operation of synchronous foveation mode switching in accordance with some aspects of the disclosure. FIG. 8B illustrates an aspect in which an image sensor (e.g., the image sensor 700 of FIG. 7) outputs an unfoveated frame (e.g., the first frame 712) on a first logical channel CH1 (e.g., the first logical channel 722), foveated portion (e.g., the first portion 714) on a second logical channel CH2 (e.g., the second logical channel 724), and a downsampled frame (e.g., the second frame 716) on a third logical channel (e.g., the third logical channel 726).

In this configuration, the image sensor is configured to only use a logical channel configuration and, when a foveation enable signal indicates foveation is disabled, the image sensor can switch logical channel output without any delay. For example, in time period 810, the image sensor is outputting a foveated portion of a frame on logical channel CH2 and a downsampled frame on logical channel CH3. Foveation is disabled at the end of time period 810 and the image sensor is able to switch to output of the unfoveated frame without any delay during time period 812 and can then switch back to foveated output in time period 814. For example, if the user captures a screenshot that is rendered on the XR device, the image sensor is able to immediately switch outputs and ensure that the next frame is unfoveated.

FIG. 8C illustrates an aspect in which an image sensor (e.g., the image sensor 700 in FIG. 7) outputs an unfoveated frame (e.g., the first frame 712) on a first logical channel CH1 (e.g., the first logical channel 722), foveated portion (e.g., the first portion 714) on a second logical channel CH2 (e.g., the second logical channel 724), and a downsampled frame (e.g., the second frame 716) on a third logical channel (e.g., the third logical channel 726).

In this configuration, the image sensor is configured to only use a logical channel configuration and can output content both foveated and unfoveated content during a switching interval. For example, in time period 820, the image sensor outputs a foveated portion of a frame on logical channel CH2 and a downsampled frame on logical channel CH3. Foveation is disabled at the end of time period 820 and the image sensor is able to switch to output unfoveated frame on logical channel CH1 and foveated frames on logical channel CH2 and logical channel CH3 during time period 822. In this case, the ISP may be configured to blend the foveated and unfoveated portions for time period 822 to create a seamless transition between the two modes without the user perceiving the change. At the end of time period 822, the image sensor only outputs on logical channel CH1 for time period 824. At the end of time period 824, the image sensor switches from unfoveated output to foveated output and output unfoveated frame on logical channel CH1 and foveated frames on logical channel CH2 and logical channel CH3 during time period 826.

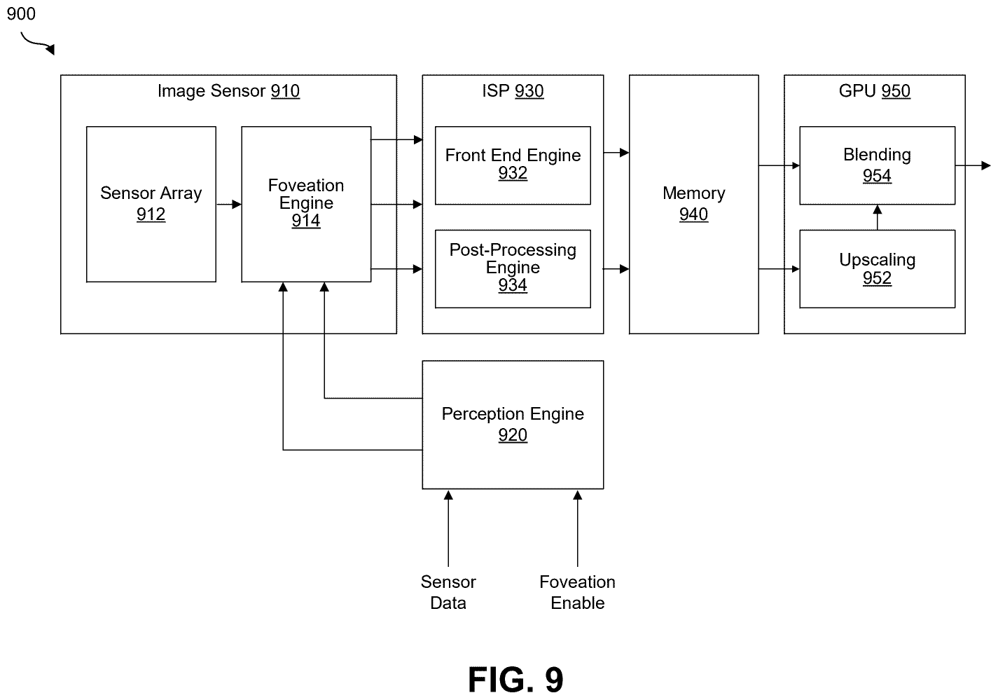

FIG. 9 illustrates a conceptual diagram of an XR device 900 for synchronous foveation mode switching in accordance with some aspects of the disclosure. In some aspects, the XR device 900 includes an image sensor 910, a perception engine 920, an ISP 930, memory 940, and a GPU 950.

The image sensor 910 includes a sensor array 912 configured to capture lights (e.g., the sensor array 702 in FIG. 7) and a foveation engine 914 to readout the sensor array 912 and convert the pixels into a foveated stream of frames and/or an unfoveated stream of frames. For example, the foveation engine 914 can include an ADC (e.g., the readout circuit 704), a binner (e.g., the binner 706), an interface (e.g., the interface 708), and a foveation controller (e.g., the foveation controller 710).

The perception engine 920 is configured to provide information the foveation engine 914 to control the foveated and/or unfoveated output of the image sensor 910. The XR device 900 can also include a collection of sensors (not shown) such as a gyroscope sensor, eye sensors, and head motion sensors for receiving eye tracking information and head motion information. The perception engine 920 can use the various motion information, including motion from the gyroscope sensor, to identify a focal point of the user in a frame. The perception engine 920 may, for example, generate a mask corresponding to a foveated region and a peripheral region and provide the mask to the image sensor 910 along with other foveation information (e.g., interleaving, scaling, etc.). The perception engine 920 can generate a foveation enable signal based on the motion information.

The perception engine 920 may also receive an external foveation enable signal that overrides the perception engine 920. For example, the perception engine 920 may receive an indication that a user has depressed a button to capture a screenshot or a video, which will cause the perception engine 920 to disable foveation for the duration needed for the screenshot or video.

The ISP 930 is configured to receive foveated and unfoveated frames from the image sensor 910 and process the frames based on foveated and/or unfoveated. In some aspects, the ISP 930 uses the different logical channels to distinguish different streams to simplify processing management. For example, the ISP 930 includes a front-end engine 932 that may process the fovea region stream using fewer image signal processing operations for the peripheral region of the frame(s) as compared to image signal processing operations performed for the fovea region of the frame(s), such as by perform basic corrective measures such as tone correction. The front-end engine 932 can identify the fovea region and the peripheral region based on the logical channel on which the frame is received 930, thereby reducing operations on the peripheral region. The ISP 930 can also include a post-processing engine 934 to perform sharpening on the fovea region of the frame to improve distinguishing edges.

The ISP 930 writes the foveated stream to a memory 940 (e.g., a shared memory, a buffer, etc.), and the GPU 950 retrieves the frames from memory 940. For example, the peripheral region of a foveated frame (e.g., the second frame 716 in FIG. 7) may be provided to an upscaling engine 952 that can upscale the foveated frame to increase the resolution of the peripheral region to the first resolution. A blending engine 954 can receive the upscaled foveated frame and may blend the upscaled foveated frame with the fovea region (e.g., the first portion 714 of the first frame in FIG. 7). In some aspects, the blending engine 954 may also blend a combination of the foveated frame and the unfoveated frame. In other aspects, the blending engine 954 may blend the unfoveated frame with the foveated frame to reduce bandwidth consumed by the system 900 (e.g., by the memory 940).

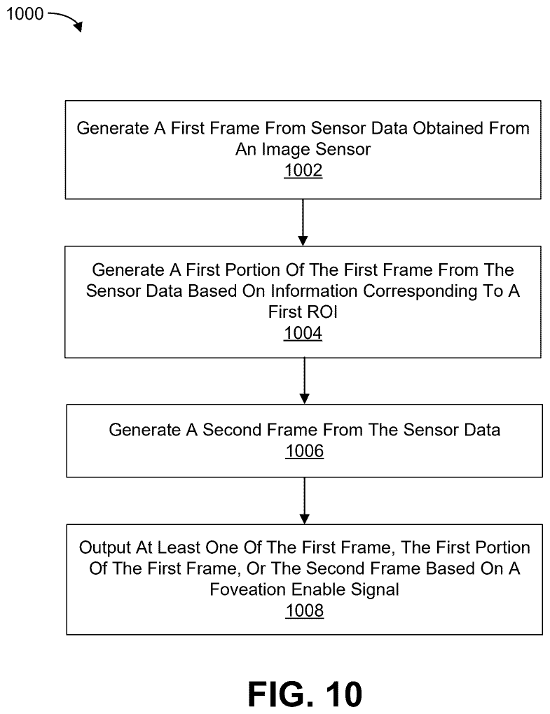

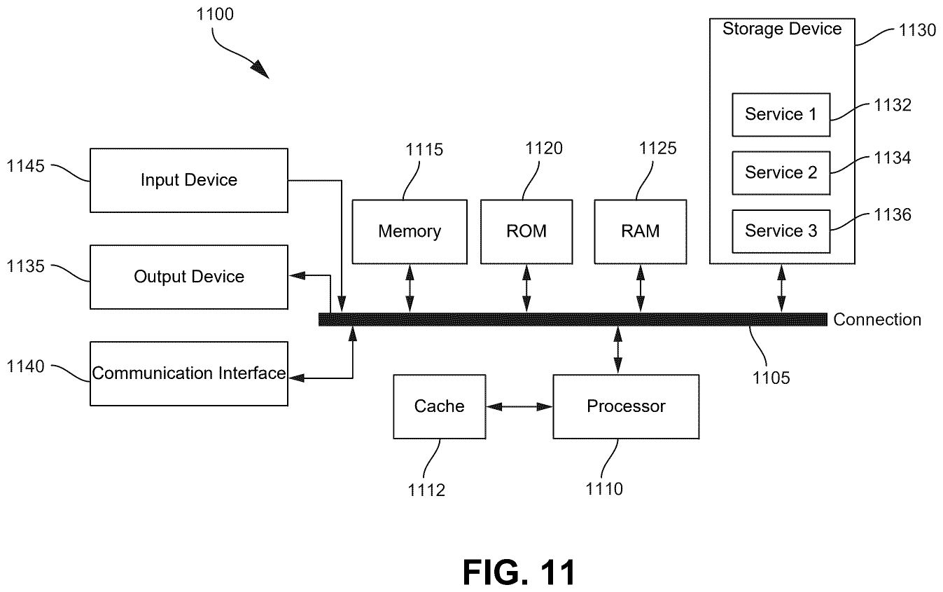

FIG. 10 is a flowchart illustrating an example process 1000 for processing images in accordance with aspects of the present disclosure. The process 1000 can be performed by a computing device (or apparatus) or a component or system (e.g., a chipset, a processor, codec, any combination thereof, and/or other component or system) of the computing device. In some aspects, the computing device may include an ISP. The computing device may be a mobile device (e.g., a mobile phone), a network-connected wearable such as a watch, an XR device (e.g., a VR device or AR device), a vehicle or component or system of a vehicle, or other types of computing device. The operations of the process 1000 may be implemented as software components that are executed and run on one or more processors (e.g., CPU 102, GPU 104, DSP 106, and/or NPU 108 of FIG. 1, the processor 1110 of FIG. 11, or other processor(s)). In another example, the process 1000 may be performed by an image sensor. In some aspects, the computing device may include an image sensor array configured to capture light. In some cases, an analog-to-digital converter is configured to convert the light into the sensor data. Further, the transmission and reception of signals by the computing device in the process 1000 may be enabled, for example, by one or more antennas, one or more transceivers (e.g., wireless transceiver(s)), and/or other communication components of the computing device.

At block 1002, the computing device (or component thereof) can generate a first frame (e.g., the first frame 712 of FIG. 7) from sensor data generated by the image sensor. In one example, the first frame may be a native resolution output by the image sensor array.

At block 1004, the computing device (or component thereof) can generate a first portion of the first frame (e.g., the first portion 714 of the first frame 712 FIG. 7) from the sensor data based on information corresponding to a first ROI. For example, the first frame may be an unfoveated image.

At block 1006, the computing device (or component thereof) can generate a second frame (e.g., the second frame 716 of FIG. 7) from the sensor data. The second frame has a second resolution that is less than the first resolution. For example, the first frame may be a native resolution of the image sensor array, the first portion of the first may be a foveated region (e.g., an ROI of the first frame), and the second frame may be a downscaled version of the first frame.

At block 1008, the computing device (or component thereof) can output at least one of the first frame, the first portion of the first frame, or the second frame based on a foveation enable signal (e.g., the foveation enable signal received by the foveation controller 710 of FIG. 7). In some aspects, the first frame, the first portion of the first frame, and the second frame are captured with a single exposure at a point in time.

In some aspects, the computing device (or component thereof) can output the first frame, first portion of the frame, and the second frame on different logical channels. For example, the computing device (or component thereof) can output the first frame on a first logical channel (e.g., the first logical channel 722 of FIG. 7) of a display bus, output the first portion of the first frame on a second logical channel (e.g., the second logical channel 724 of FIG. 7) of the display bus, and output the second frame on a third logical channel (e.g., the third logical channel 726 of FIG. 7) of the display bus.

In some aspects, the first logical channel is enabled or the second logical channel and the third logical channel are enabled for each output by the image sensor. In such aspects, logical channels are used as the transport mechanisms and the image sensor can avoid a costly (in terms of time) switch between a physical channel for the unfoveated image and a logical channel for a foveated image. For example, in response to receiving a signal enabling foveated output in a first sequential frame, the image sensor may output the first portion of the first frame and the second frame in a second sequential frame that is directly after the first frame. In another example, the image sensor may, in response to receiving a signal disabling foveated output in the first sequential frame, output the first frame in a second sequential frame.

In either example, the image sensor is able to switch between foveated and unfoveated frames without any hardware reconfiguration. Hardware reconfiguration takes enough time to create a delay between foveated and unfoveated, which can create undesirable visual artifacts and degrade the viewing experience. For example, the image sensor may receive a signal to disable foveated output based on eye tracking failure, a screenshot, or a screen recording. The configuration described above allows the image sensor to switch to an unfoveated frame and output the unfoveated frame without any delay.

In another example, the image sensor may output each of the first frame, the first portion of the first frame, and the second frame based during a foveation mode switch. In this case, the image signal processor or configure its operation based on having each of the different variants of the frame. For example, the image signal processor can be processing frames in various manners, and may need to determine which image can be presented based on a processing state of other devices within the system. In this case, providing each frame for a brief period consumes more bandwidth for a brief period, but provides flexibility to other processing devices and functions within an image processing pipeline of the device (e.g., the image signal processor, supplemental processing by a GPU, blending, etc.).

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive IP-based data or other type of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

The process 1000 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1000 and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 11 is a diagram illustrating an example of a system for implementing certain aspects of the present technology. In particular, FIG. 11 illustrates an example of computing system 1100, which may be for example any computing device making up internal computing system, a remote computing system, a camera, or any component thereof in which the components of the system are in communication with each other using connection 1105. Connection 1105 may be a physical connection using a bus, or a direct connection into processor 1110, such as in a chipset architecture. Connection 1105 may also be a virtual connection, networked connection, or logical connection.

In some embodiments, computing system 1100 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1100 includes at least one processing unit (CPU or processor) 1110 and connection 1105 that communicatively couples various system components including system memory 1115, such as ROM 1120 and RAM 1125 to processor 1110. Computing system 1100 may include a cache 1112 of high-speed memory connected directly with, in close proximity to, or integrated as part of processor 1110.

Processor 1110 may include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which may represent any number of input mechanisms, such as a microphone for speech, a touch-sensitive screen for gesture or graphical input, keyboard, mouse, motion input, speech, etc. Computing system 1100 may also include output device 1135, which may be one or more of a number of output mechanisms. In some instances, multimodal systems may enable a user to provide multiple types of input/output to communicate with computing system 1100.

Computing system 1100 may include communications interface 1140, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1130 may include software services, servers, services, etc., that when the code that defines such software is executed by the processor 1110, it causes the system to perform a function. In some embodiments, a hardware service that performs a particular function may include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A method of generating one or more frames, comprising: generating a first frame from sensor data obtained from an image sensor, wherein the first frame has a first resolution; generating a first portion of the first frame from the sensor data based on information corresponding to a first region of interest (ROI); generating a second frame from the sensor data, wherein the second frame has a second resolution that is less than the first resolution; and outputting at least one of the first frame, the first portion of the first frame, or the second frame based on a foveation enable signal.

Aspect 2. The method of Aspect 1, wherein the first frame, the first portion of the first frame, and the second frame are captured with a single exposure at a point in time.

Aspect 3. The method of any of Aspects 1 to 2, wherein the first frame is output on a first logical channel of a display bus, the first portion of the first frame is output on a second logical channel of the display bus, and the second frame is output on a third logical channel of the display bus.

Aspect 4. The method of Aspect 3, wherein the first logical channel is enabled or the second logical channel and the third logical channel are enabled for each output by the image sensor.

Aspect 5. The method of any of Aspects 1 to 4, further comprising, in response to receiving a signal enabling foveated output in a first sequential frame, outputting the first portion of the first frame and the second frame in a second sequential frame.

Aspect 6. The method of Aspect 5, further comprising, in response to receiving a signal disabling foveated output in the first sequential frame, outputting the first frame in a second sequential frame.

Aspect 7. The method of any of Aspects 1 to 6, further comprising receiving, by the image sensor, a signal to disable foveated output based on eye tracking failure, a screenshot, or a screen recording.

Aspect 8. The method of any of Aspects 1 to 7, further comprising outputting each of the first frame, the first portion of the first frame, and the second frame based during a foveation mode switch.

Aspect 9. The method of any of Aspects 1 to 8, further comprising capturing the sensor data using the image sensor.

Aspect 10. An apparatus for generating one or more frames, the apparatus comprising at least one memory and at least one processor coupled to the at least one memory and configured to: generate a first frame from sensor data obtained by an image sensor, wherein the first frame has a first resolution; generate a first portion of the first frame from the sensor data based on information corresponding to a first region of interest (ROI); generate a second frame from the sensor data, wherein the second frame has a second resolution that is less than the first resolution; and output at least one of the first frame, the first portion of the first frame, or the second frame based on a foveation enable signal.

Aspect 11. The apparatus of Aspect 10, the first frame, the first portion of the first frame, and the second frame are captured with a single exposure at a point in time.

Aspect 12. The apparatus of any of Aspects 10 to 11, wherein the first frame is output on a first logical channel of a display bus, the first portion of the first frame is output on a second logical channel of the display bus, and the second frame is output on a third logical channel of the display bus.

Aspect 13. The apparatus of Aspect 12, wherein the first logical channel is enabled or the second logical channel and the third logical channel are enabled for each output by the image sensor.

Aspect 14. The apparatus of any of Aspects 10 to 13, wherein the at least one processor is configured to: in response to receiving a signal enabling foveated output in a first sequential frame, outputting the first portion of the first frame and the second frame in a second sequential frame.

Aspect 15. The apparatus of Aspect 14, wherein the at least one processor is configured to: in response to receiving a signal disabling foveated output in the first sequential frame, outputting the first frame in a second sequential frame.

Aspect 16. The apparatus of any of Aspects 10 to 15, wherein the at least one processor is configured to: receiving, by the image sensor, a signal to disable foveated output based on eye tracking failure, a screenshot, or a screen recording.

Aspect 17. The apparatus of any of Aspects 10 to 16, wherein the at least one processor is configured to: outputting each of the first frame, the first portion of the first frame, and the second frame based during a foveation mode switch.

Aspect 18. The apparatus of any of Aspects 10 to 17, wherein the at least one processor is configured to: further comprising capturing the sensor data using the image sensor.

Aspect 19. A non-transitory computer-readable medium having stored thereon instructions that, when executed by at least one processor, cause the at least one processor to perform operations according to any of Aspects 1 to 9.

Aspect 20. An apparatus for generating one or more frames, comprising one or more means for performing operations according to any of Aspects 1 to 9.

What is claimed is:

1. A method of generating one or more frames, comprising:
generating a first frame from sensor data obtained from an image sensor, wherein the first frame has a first resolution;
generating a first portion of the first frame from the sensor data based on information corresponding to a first region of interest (ROI);
generating a second frame from the sensor data, wherein the second frame has a second resolution that is less than the first resolution; and
outputting at least one of the first frame, the first portion of the first frame, or the second frame based on a foveation enable signal.

2. The method of claim 1, wherein the first frame, the first portion of the first frame, and the second frame are captured with a single exposure at a point in time.

3. The method of claim 1, wherein the first frame is output on a first logical channel of a display bus, the first portion of the first frame is output on a second logical channel of the display bus, and the second frame is output on a third logical channel of the display bus.

4. The method of claim 3, wherein the first logical channel is enabled or the second logical channel and the third logical channel are enabled for each output by the image sensor.

5. The method of claim 1, further comprising, in response to receiving a signal enabling foveated output in a first sequential frame, outputting the first portion of the first frame and the second frame in a second sequential frame.

6. The method of claim 5, further comprising, in response to receiving a signal disabling foveated output in the first sequential frame, outputting the first frame in a second sequential frame.

7. The method of claim 1, further comprising receiving, by the image sensor, a signal to disable foveated output based on eye tracking failure, a screenshot, or a screen recording.

8. The method of claim 1, further comprising outputting each of the first frame, the first portion of the first frame, and the second frame based during a foveation mode switch.

9. The method of claim 1, further comprising capturing the sensor data using the image sensor.

10. An apparatus for generating one or more frames, the apparatus comprising:
at least one memory; and
at least one processor coupled to the at least one memory and configured to:
generate a first frame from sensor data generated by an image sensor, wherein the first frame has a first resolution;
generate a first portion of the first frame from the sensor data based on information corresponding to a first region of interest (ROI);
generate a second frame from the sensor data, wherein the second frame has a second resolution that is less than the first resolution; and
output at least one of the first frame, the first portion of the first frame, or the second frame based on a foveation enable signal.

11. The apparatus of claim 10, wherein the first frame, the first portion of the first frame, and the second frame are captured with a single exposure at a point in time.

12. The apparatus of claim 10, wherein the first frame is output on a first logical channel of a display bus, the first portion of the first frame is output on a second logical channel of the display bus, and the second frame is output on a third logical channel of the display bus.

13. The apparatus of claim 12, wherein the first logical channel is enabled or the second logical channel and the third logical channel are enabled for each output by the image sensor.

14. The apparatus of claim 10, wherein the at least one processor is configured to:
in response to receiving a signal enabling foveated output in a first sequential frame, output the first portion of the first frame and the second frame in a second sequential frame.

15. The apparatus of claim 14, wherein the at least one processor is configured to:
in response to receiving a signal disabling foveated output in the first sequential frame, output the first frame in a second sequential frame.

16. The apparatus of claim 10, wherein the at least one processor is configured to:
receive, by the image sensor, a signal to disable foveated output based on eye tracking failure, a screenshot, or a screen recording.

17. The apparatus of claim 10, wherein the at least one processor is configured to:
output each of the first frame, the first portion of the first frame, and the second frame based during a foveation mode switch.

18. The apparatus of claim 10, further comprising:
an image sensor array configured to capture light; and
an analog-to-digital converter configured to convert the light into the sensor data.

19. A non-transitory computer-readable medium having stored thereon instructions that, when executed by at least one processor, cause the at least one processor to:
generate a first frame from sensor data generated by an image sensor, wherein the first frame has a first resolution;
generate a first portion of the first frame from the sensor data based on information corresponding to a first region of interest (ROI);
generate a second frame from the sensor data, wherein the second frame has a second resolution that is less than the first resolution; and
output at least one of the first frame, the first portion of the first frame, or the second frame based on a foveation enable signal.

20. The non-transitory computer-readable medium of claim 19, wherein the first frame, the first portion of the first frame, and the second frame are captured with a single exposure at a point in time.
